(19) United States
(12) Patent Application Publication
(10) Pub. No.: US 2002/0071181 A1
(43) Pub. Date: Jun. 13, 2002

(54) Polarisation splitting circulator method and device

(75) Inventor: Steven James Frisken, Randwick (AU)

Correspondence Address: Ladas & Parry, 261 West 61st Street, New York, NY, 10023, US

(73) Assignee: Nortel Networks (Photonics) PTY LTD.

(21) Appl. No.: 09/736,095

(22) Filed: Dec. 13, 2000

(51) Int. Cl. G02B 6/00; G02B 5/30; G02B 27/28

(52) U.S. Cl. 359/484; 359/495; 359/497; 385/11

(57) ABSTRACT

An optical circulator type device comprising: first, second, third and fourth input/output waveguides; a series of optical elements including polarisation rotation elements; wherein input light omitted from the first input/output waveguide traverses the series of optical elements which spatially separate the light into orthogonal polarisation states, projecting them towards the second and third input/output waveguides respectively; and polarised input light emitted from the second and third input/output waveguides traverse the series of optical elements and is combined at the fourth input/output waveguide.

### FIELD OF THE INVENTION

The present invention provides an arrangement of elements for providing a polarisation splitting circulator method and device.

### BACKGROUND OF THE INVENTION

Many optical components which perform functions of use in the field of telecommunications are restricted in their application because their operation is to some extent polarisation dependent. The polarisation dependence may be in the form of a polarisation dependent loss (PDL), a polarisation mode dispersion (PMD) due to birefringence, or polarisation dependent shift of spectral characteristics.

Polarisation sensitivity is a particular problem in integrated optical circuits (IOCs). The polarisation sensitivity of IOCs is mainly due to the fact that they are either not symmetric in their construction or they have been subjected to uneven fabrication stresses. This causes IOCs to exhibit a residual birefringence. As a consequence, IOCs which rely on phase matching, such as tunable couplers or Mach-Zehnder interferometers may tend to exhibit a polarisation dependent spectral shift and polarisation mode dispersion.

Polarisation independent operation is difficult to achieve in IOCs. Consequently, many different approaches have been tried to balance the polarisation response of such devices. For example, phase trimming and polarisation flipping are known techniques. However, these techniques are not satisfactory for large scale manufacturing processes.

In a similar fashion to IOCs, the efficiency of bulk grating devices and holographic devices may also be highly polarisation dependent.

Clearly it can be seen that a much wider range of optical component designs may be possible if the behavior of only one polarisation state needs to be considered.

### SUMMARY OF THE INVENTION

It is an object of the present invention to provide a polarisation splitting circulating type device.

In accordance with a first aspect of the present invention, there is provided an optical device comprising: at least first, second and third input/output waveguides; a series of optical elements between the first waveguide and the second and third waveguide, the optical elements including polarisation state manipulation elements; wherein input light emitted from the first input/output waveguide transverse members of the series of optical elements which spatially separate orthogonal polarisation states, projecting them towards the second and third input/output waveguides respectively; and polarised input light emitted from the second and third input/output waveguides traverse members of the series of optical elements and projects them spatially away from the first input/output waveguide.

Preferably, the polarised input light emitted from the second and third input/output waveguides is spatially combined at a fourth waveguide and the polarised input light emitted from the second and third input/output waveguides can be spatially combined at the fourth waveguide in a substantially orthogonal manner.

The polarisation state manipulation elements can include at least one of a non-reciprocal rotator, a polarisation dependent separation element or polarisation dependent alignment element. The spatially separate orthogonal polarisation states are preferably further rotationally aligned at the second and third waveguides.

Preferably, the input light emitted from the fourth input/output waveguide also traverses members of the series of optical components and can be output at a fifth waveguide, spatially separated from the second and third waveguides.

The optical components adjacent the first input/output waveguide can comprise a first polarisation dependent separation means for spatially separating orthogonal polarisation states; polarisation alignment means for aligning the spatially separated orthogonal polarisation states to produce aligned polarisation states; a first non-reciprocal rotator for rotating the aligned polarisation states in a non-reciprocal manner; a second polarisation separation means for spatially translating the aligned polarisation states, focussing means for focussing the polarisation states; a third polarisation separation means for further spatially translating the aligned polarisation states to produce translated polarisation states; a second non-reciprocal rotator for rotating the translated polarisation states in a non-reciprocal manner to produce second rotated polarisation states; a polarisation alignment means for rotating one of the second rotated polarisation state with respect to a second to produce second orthogonal polarisation states; and a fourth polarisation dependent separation means for further spatially separating the second orthogonal polarisation states to produce separated polarisation output states.

The system can further include a second polarisation alignment means for rotating one of the separated polarisation output states with respect to a second to produce aligned spatially separated polarisation output states.

In accordance with a further aspect of the present invention, there is provided a method of manipulating and transmitting the polarisation states of a first, second and third input optical signal through a series of optical elements, the method comprising the steps of: (a) projecting the first input optical signal through first predetermined members of a series of polarisation manipulation elements which separate spatially separate and orient orthogonal polarisation states of the input optical signal spatially separated outputs; (b) projecting the second and third input optical signal through second predetermined members of the series of polarisation manipulation elements which combine the second and third input optical signal in a substantially orthogonal manner to output a third output. The third output can be spatially separated from the first input optical signal location.

In accordance with a further aspect of the present invention, there is provided an optical device comprising: a series of optical manipulation element that spatially separate substantially orthogonal polarisation states of a first input signal input at a first position to produce second and third output signals output at a second and third position respectively, and further spatially combines in a substantially orthogonal manner, signals input from the second and third position for output at a fourth position.

In accordance with a further aspect of the present invention, there is provided an optical device comprising: a polarisation manipulation element that spatially separate substantially orthogonal polarisation states of a first input signal input at a first position to produce second and third output signals output at a second and third position respectively, and further spatially combines in a substantially orthogonal manner signals input from the second and third position for output at a fourth position; and a second element which preferably can include two input ports located at the second and third position respectively, the second element manipulating each of the second and third output signals in a predetermined manner before returning the signals to the second and third position wherein they are spatially combined by the polarisation manipulation element for output at the fourth position.

The second element can comprise a separate polarisation mode dispersion device for acting on each of the second and third output signals. The polarisation mode dispersion device can comprise a chirped grating. Alternatively, the second element can comprise an optical amplifier having an amplifying waveguide interconnecting the second position with the first position, or a wavelength dependant attenuation filter or phase filter.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 shows a schematic representation of an exploded arrangement constructed according to an embodiment of the invention;

FIG. 2 shows a polarisation state transition diagram for an optical signal coupled into a port of the arrangement according to the embodiment of FIG. 1;

FIG. 3 shows the return path through the arrangement of FIG. 1 and FIG. 2, for an optical signal having spatially separated, parallel polarisation states coupled into the device;

FIG. 4 shows a polarisation state transition diagram for the arrangement of the embodiment of FIGS. 1 to 3 for an optical signal coupled into port D of the arrangement;

FIG. 5 is a schematic representation of the incorporation of a polarisation splitting circulator into a first device comprising a gain filter;

FIG. 6 is a schematic representation of the incorporation of a polarisation splitting circulator into a second device comprising a wavelength dependant filter;

FIG. 7 is a schematic representation of the incorporation of a polarisation splitting circulator into a third device comprising a wavelength dependant interference filter;

FIG. 8 is a schematic representation of the incorporation of a polarisation splitting circulator into a device comprising a polarisation dependant delay device;

FIG. 9 is a schematic representation of the incorporation of a polarisation splitting circulator into a device comprising a polarisation independent amplifier; and

FIG. 10 is a schematic illustration of the further incorporation of the arrangement of FIG. 9 into a telecommunications system.

### DETAILED DESCRIPTION OF THE EMBODIMENTS

In the first embodiment, a circulator having a polarisation splitter is provided which utilises a series of optical components to resolve an optical signal, initially having two orthogonal polarisation states into an output signal with spatially separated, but aligned polarisations. In the reverse path, the two aligned polarisations are orthogonally combined by the same optical components and output at a separate output port.

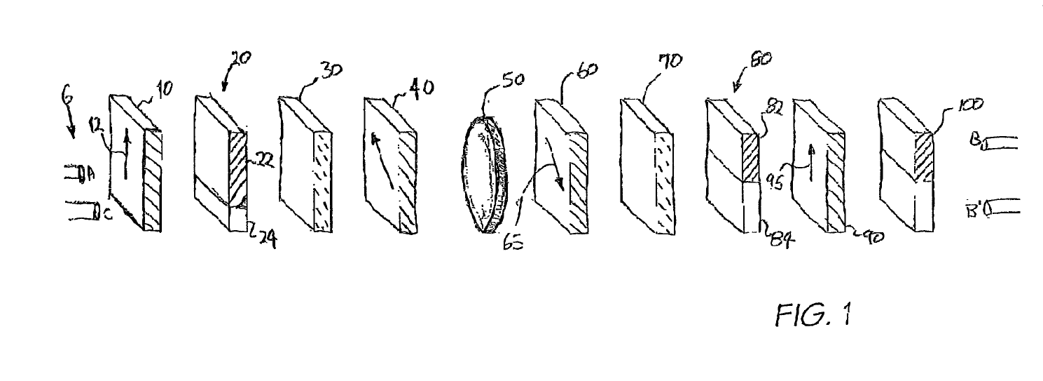

FIG. 1 shows a schematic illustration of an exploded optical arrangement 5 of the first embodiment. The arrangement 5 includes an first series 6 and a second series 7 of optical fibres. Each of the fibre is approximately 125 microns in diameter and can include a short length of gradient index fibre attached to their ends, or other form of mode expansion as will be known to a person skilled in the art. The fibre denoted A and e are spaced one above the other. The fibres denoted B and B′ are spaced one above the other and fibre denoted D is spaced apart from the fibre B′.

The device proper consists of the following components:

1. A first walk off crystal 10 is provided and can comprise a rutile crystal with a width of approximately 1 millimeter. The walk off crystal 10 is positioned adjacent to the gradient indexed fibre and is of sufficient dimension to separate the polarisation states projected from the fibres. The walk-off plate 10 is adapted to provided a displacement in the direction of arrow 12.

2. Next, an element 20 comprising a top half wave plate 22 in the top two thirds of the element and a second glass section 24 in the bottom portion of the element is provided. The half wave plate achieves a 90° reciprocal rotation in the polarisation states in the paths affected.

3. Next, a Faraday rotator 30 is provided to rotate all polarisation states by 45° in a non reciprocal manner.

4. Next, a second rutile plate 40 is provided to provide a displacement in the polarisation states in a direction 45 which is 45° to the horizontal.

5. Next a lens 50 is provided for focusing the emitted rays.

6. A further rutile plate 60 is provided to shift the polarisation states in direction 65 which is −45° to the horizontal.

7. Next, a further Faraday rotator 70 is provided to produce a non reciprocal 45° rotation in all polarisation states.

8. The next element 80 comprises a half wave plate 82 in the top section the element and a blank glass section 84 in the bottom half of the element.

9. A further rutile plate 90 is provided for producing a shift in the polarisation states in the direction 95.

10. Finally, a further element 100 identical to element 80 is provided. This element includes a half-wave plate which achieves a 90° rotation in polarisation states in the top half of the path of the element and produces no effect on polarisation states in the bottom paths of the element.

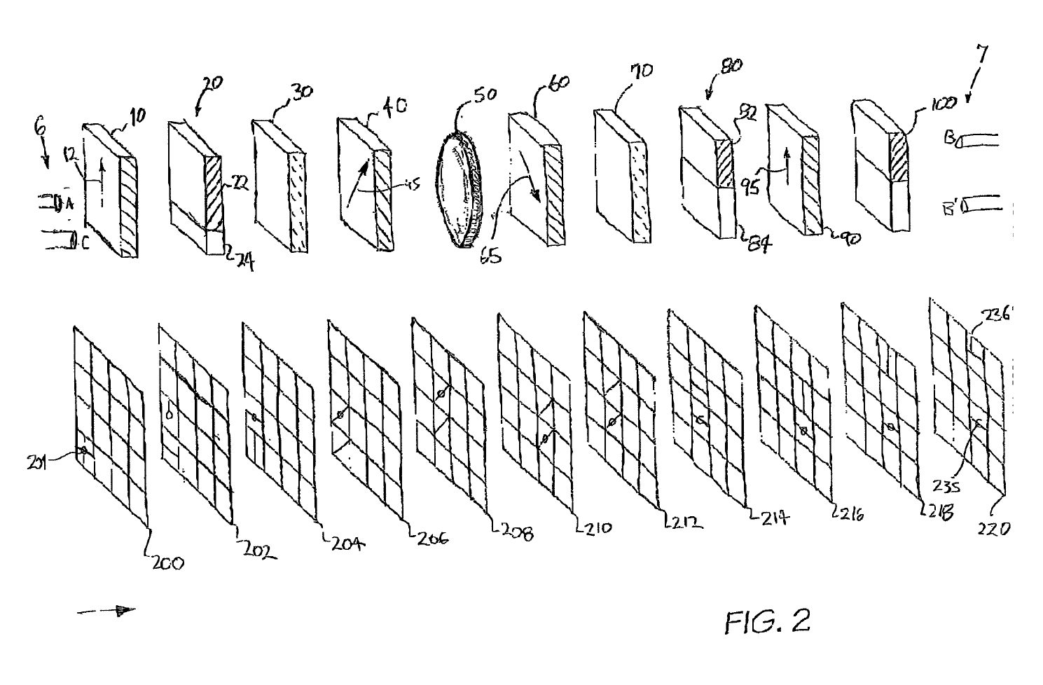

The arrangement 5 is useful in spatially separating and aligning the polarisation states of an optical signal which traverses the arrangement 5 from left to right, and for providing spatially coincident polarisation states when a plurality of optical signals having spatially separated polarisation states are applied to the arrangement 5 from right to left. The embodiment also provides for a form of optical circulation of the inputs. The above features will be illustrated in connection with polarisation state transition diagrams as depicted in FIGS. 2, 3 and 4.

Turning now to FIG. 2, which shows a series of polarisation state transition diagrams corresponding to a process whereby light having two orthogonal polarisation states 201 is coupled from the input fibre A of the arrangement 5 and the polarisation states are split into 2 parallel spatially separated but aligned polarisation states 230, 235 which are output from output fibres B and B′, respectively.

Initially the light input from port A can be defined to have spatially coincident orthogonal polarisation states as represented by cross 201. The light then traverses walk off plate 10 which provides spatial separation of the polarisation states 202. Next, the half wave plate portion 22 of element 20 produces a 90° rotation in one of the polarisation states thereby achieving two parallel polarisation states 204. Faraday rotator 30 rotates both polarisation states by 45° 206. Then lens 50 inverts the light about a central axis resulting in polarisation state 210. The next element traversed is a further walk off plate 60. This walk off plate has no effect on the polarisation state, thus it remains unchanged 212. Faraday rotator 70 produces a further 45° clockwise rotation in the polarisation states 214. The combined half wave and blank glass element 80 rotates the upper polarisation state, resulting in two orthogonal polarisations 216. The light then traverses a further walk off plate 90 which further spatially separates the two orthogonal polarisation states resulting in state 218. Half wave and blank glass element 100 again realigns the polarisation states 230, 235 resulting in polarisation state diagram 220. The two aligned polarisation states 235, 236 can then be outputted to fibre output ports B and B′.

Thus it can be seen that by traversing arrangement 5, an optical signal applied to port is resolved into 2 parallel but spatially separated polarisation states output at B and B′. The resulting parallel polarisation states 230, 235 can then be coupled into a further device and manipulated in a polarisation independent manner as will be described below.

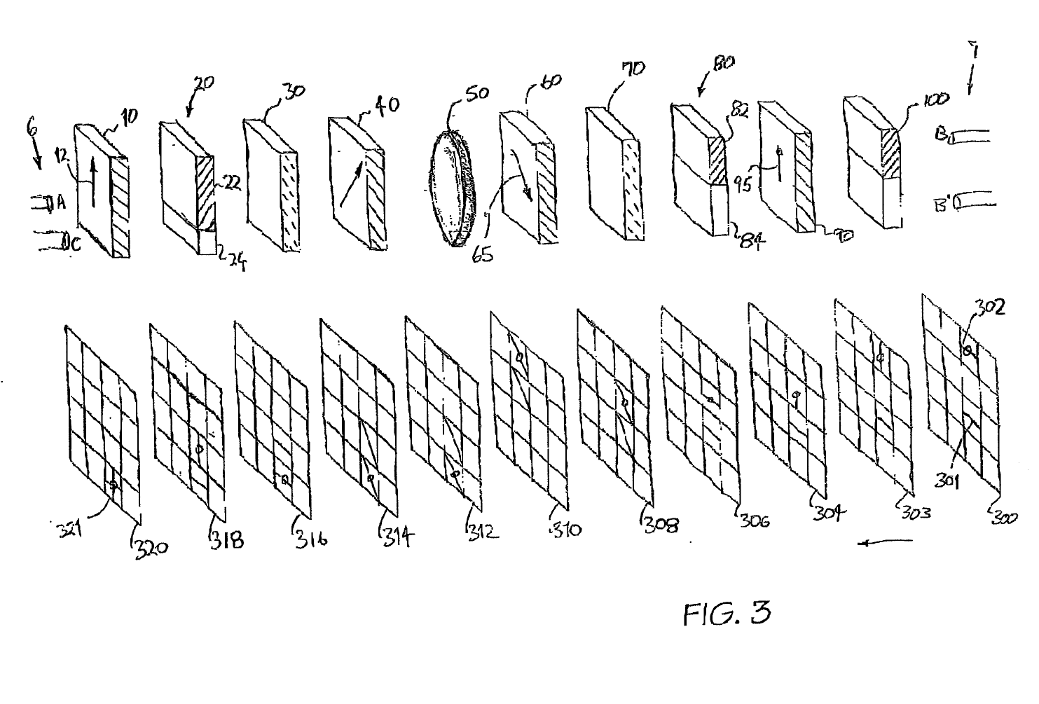

Turning now to FIG. 3 there is shown a series of polarisation state transition diagrams for the case where two parallel but spatially separated polarisation states 301, 302 are coupled into ports B and B′ of the arrangement 5. The initial polarisation states are shown in diagram 300. In the return path the first element traversed is the combined half wave and blank element 100 resulting in polarisation state 303. Next, the walk off plate 90 shifts one of the orthogonal states resulting in polarisation state 304. The next half wave and blank element 80 results in the polarisation states being aligned 306. And Faraday rotator 70 rotates the polarisation states by 45° 308. The walk off plate 60 then shifts both polarisation states resulting in polarisation state 310. Again the lens 50 produces an inversion about its central axis resulting in polarisation state 312. Walk off plate 40 has no effect on the polarisation states 314. Both polarisation states are rotated by 45° in the anti-clockwise direction by Faraday rotator 30, resulting in polarisation state 316. The next element traversed is a half wave and blank element 20 which rotates the upper most of the polarisations resulting in 2 orthogonal polarisation states as shown in diagram 318. By traversing walk off plate 10, orthogonal and spatially coincident polarisation states are achieved 320.

Thus it can be seen that traversing the arrangement 5 from right to left produces a different from the effect of traversing arrangement 5 from left to right that is, two parallel polarisations of light coupled into ports B and B′ of optical fibre array 7 are combined into a pair of orthogonal spatially coincident polarisation states. Therefore, by comparing FIG. 2 and FIG. 3 it can be seen that light input at port A is transmitted to the output ports and light input at the ports B and B′ is transmitted to port C.

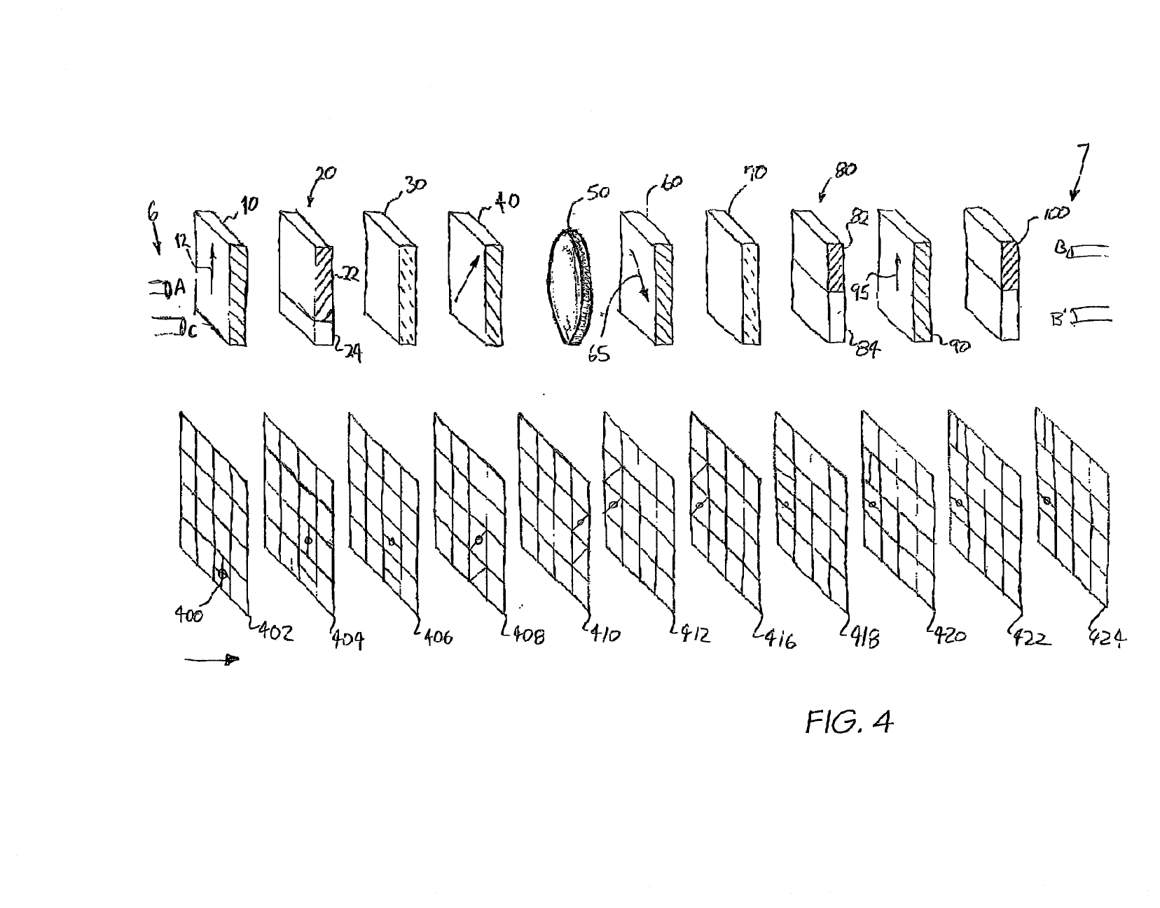

FIG. 4 shows the effect of the arrangement 5 when an input signal is applied to port C. Initially a signal 400 with orthogonal and spatially coincident polarisation states is applied to port C of the arrangement 5, as shown in polarisation state diagram 402. Walk off plate 10 produces a spatial separation of the polarisation states 404, and combined half wave and blank glass element 20 aligns the polarisation states 406. Faraday rotator 30 rotates both polarisation states by 45° in a anti-clockwise direction 408. Walk off plate 40 then shifts both polarisation states as shown by diagram 410. Next, lens 50 produces a reflection about its central axis resulting in polarisation state 412. Since the next walk off plate 60 is not aligned with the polarisation states 412 no effect is produced by the light traversing walk off plate 60, resulting in no change in polarisation state 416. Both polarisation states are rotated by 45° by Faraday rotator 70 to produce polarisation states 418. The combined half wave and blank glass element 80 produces separated states 420. The walk off plate further separates the polarisation states, which are then combined into a spatially coincident polarisation state 422 by walk off plate 90. This signal then traverses the blank section of element 100 thereby remaining unchanged 424. The light at this point is coupled to the output port D of the arrangement 5.

From the polarisation state diagrams of FIG. 2 to FIG. 4 it can be seen that the arrangement 5 acts as a “polarisation splitting circulator” with an input at port A going to ports B and B′ (with the polarisations separated). The separated return input at ports B and B′ goes to port C and on input at port C goes to port D.

The features of the embodiments described above in connection with FIGS. 2 to FIG. 4 make the arrangement 5 particularly useful in polarisation dependent fibre optic applications as will be recongised by the person skilled in the art.

For example, the separated polarisation states provided by the arrangement 5 can be coupled into a polarisation dependant waveguide or fibre arrangement or directly to a polarisation dependent optical device if an appropriate coupling means is supplied, thereby reducing the effect of the polarisation dependence of the attached device or fibre, on the processing of the signal as only one polarisation state is provided.

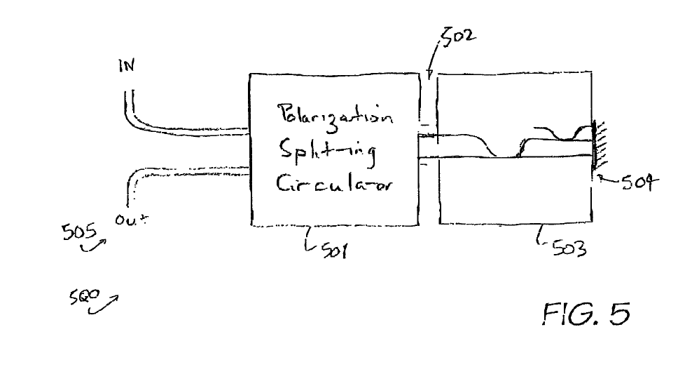

As a further example, the polarisation splitting circular can be utilised in a reflective style waveguide gain flattening filter. In FIG. 5, there is illustrated schematically a device 500 including a polarisation splitting circulator 501 as aforementioned whose aligned polarisation outputs 502 are fed to a waveguide filter 503. The filter consists of a number of coupled waveguide elements in addition to a mirror element 504. The waveguide 503 provides for gain filtering of the input polarisation components which are reflected by the mirror 504 and output back to the polarisations splitting circulator 501 before being output at output 505.

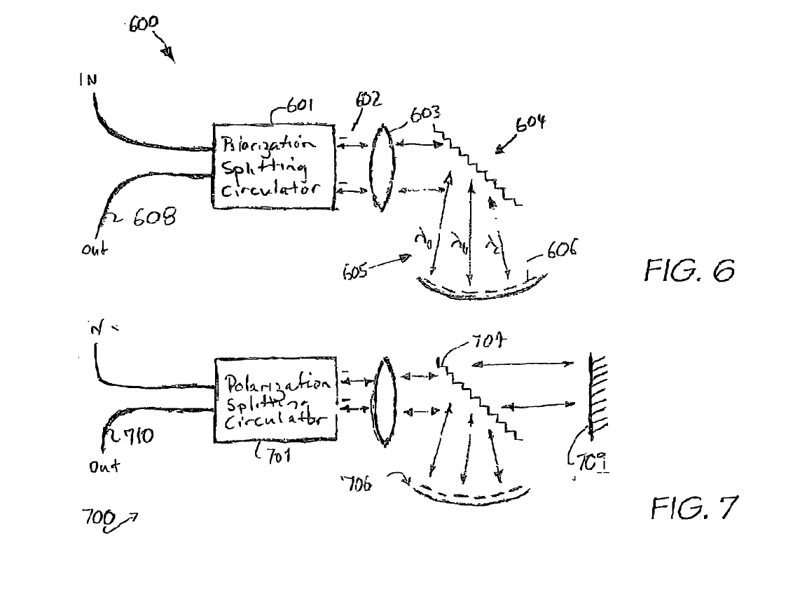

The polarisation splitting circulator can be utilised in other arrangements. For example, in FIG. 6, there is provided a variable filter whose attenuation characteristics can be wavelength dependant. In this case, the polarisation 601 outputs aligned polarisation states 602 which are forwarded to a lensing element 603 and then to a diffraction grating 604. The diffraction grating creates various magnitude orders 605 having a spatial angle which is wavelength dependent 605. The wavelength dependent orders are reflected by movable mirrors e.g., 606 with the amount of reflection being controlled by the state of the mirror. The reflected light is again forwarded back via the diffraction grating 604 to again be input to the polarisation splitting circulator 601 where it is orthogonally combined to be output via output line 608. The arrangement of FIG. 6 therefore provides for a wavelength selective attenuation of an input signal. The diffraction grating 604 and mirror system 606 can be constructed utilising a microelectromechanical system (MEMS) type environment.

The arrangement of FIG. 6 can be extended as shown in FIG. 7 so as to provide for phase dependent attenuation. In this arrangement 700, the diffraction 704 is semi transparent so that a portion of the emitted light is projected to mirror system 706 and a second portion is directed to a mirror device 709 and reflected back so as to interfere with the portion reflected from the mirror 706. The phase interference relationship can be thereby controlled by controlling the intensity of reflection from the mirror system 706. The reflected light is again forwarded to the polarisation splitting circulator which combines the light in an orthogonal manner before outputting the light 710. In this manner, it can be seen that the arrangement of FIG. 7 provides for a phase dependent wavelength dependent polarisation splitting circulator device.

A further utilisation of a polarisation splitting circulator is in a variable polarisation delay device. An example of such a device is illustrated schematically 800 in FIG. 8 which includes a polarisation splitting circulator 801 as previously described in addition to two tunable chirped gratings 803, 803. One of the gratings is coupled to each of the fibre output ports. The chirped gratings can then be tuned to provide relative group delay for each polarisation at various wavelengths. As a result, the polarisation mode dispersion can be corrected in addition to polarisation wavelength dispersion. The relative delay between the polarisation states can be used to compensate for the polarisation mode dispersion. The chirped grating can be turned by, for example, variation in stress and temperature of the grating to thereby tune the relative group delay of each polarisation for a particular wavelength.

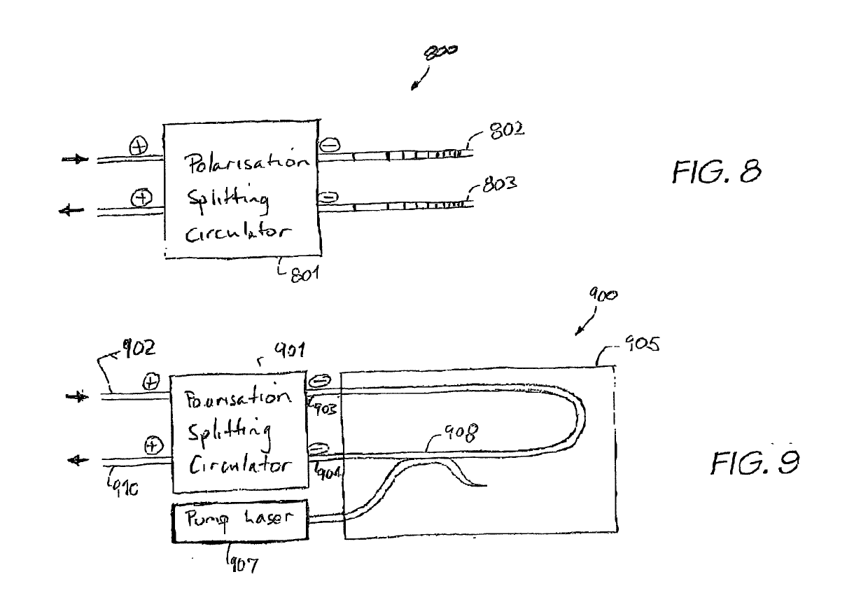

Turning now to FIG. 9, there is illustrated a further device 900 utilising a polarisation splitting circulator to provide for optical amplification in a polarisation dispersion loss free manner. In this device, the polarisation splitting circulator takes input light 902 and separates it into orthogonal polarisation states 903, 904. The separated polarisation states are fed around a waveguide amplifier 905 which can, for example, be an erbium doped optical amplification section. The amplification waveguide is pumped by a pumped laser 907 which is coupled 908 to the erbium doped fibre. As each output polarisation travels along the same path but in an opposite direction, the overall result is to provide for polarisation dispersion loss free operation of the amplifier. The two amplified polarisation states are then combined at output 910. Further, in accordance with the operation of FIG. 4, the polarisation splitting circulator acts to isolate any returned signal fed back from output port 910.

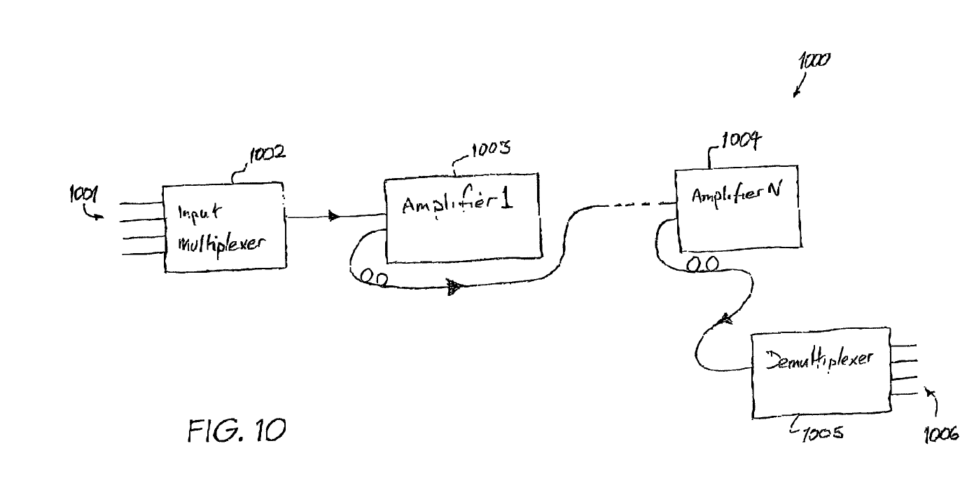

The devices utilising a polarisation splitting circulator can then be provided for use in telecommunications systems. For example, in FIG. 10 there is illustrated the incorporation of the polarisation independent amplifier into a telecommunications system 1000. In this arrangement, a series of optical signals 1001 are first multiplexed together 1002 before being fed through a series of polarisation independent amplifiers 1003, 1004 before being output demultiplexed 1005 to form output signals 1006.

By utilising a polarisation splitting circulator to separate the input polarisation states, the two polarisation states can be independently dealt with so as to minimise polarisation dependant losses and polarisation mode dispersion. Further, the circulator type operation of the preferred embodiment allows for the incorporation of the device into circulator type arrangements.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. An optical device comprising:
at least first, second and third input/output waveguide;
a series of optical elements between said first waveguide and said second and third waveguide, said optical elements including polarisation state manipulation elements;
wherein:
input light emitted from said first input/output waveguide traverses members of said series of optical elements which spatially separate orthogonal polarisation states, projecting them towards said second and third input/output waveguides respectively; and
polarised input light emitted from said second and third input/output waveguides traverse members of said series of optical elements and projects them spatially away from said first input/output waveguide.

2. An optical device as claimed in claim 1 wherein said polarised input light omitted from said second and third input/output waveguides is spatially combined at a fourth waveguide.

3. An optical device as claimed in claim 2 wherein the polarised input light emitted from said second and third input/output waveguides is spatially combined at said fourth waveguide in a substantially orthogonal manner.

4. An optical device as claimed in claim 1 wherein said polarisation state manipulation elements include at least one of a non-reciprocal rotator, a polarisation dependant separation element or polarisation dependant alignment element.

5. A device as claimed in claim 1 wherein said spatially separate orthogonal polarisation states are further rotationally aligned at said second and third waveguides.

6. A device as claimed in claim 1 wherein input light emitted from said fourth input/output waveguide traverses members of said series of optical components and is output at a fifth waveguide, spatially separated from said second and third waveguides.

7. A device as claimed in claim 1 wherein said optical components adjacent said first input/output waveguide comprise:
a first polarisation dependant separation means for spatially separating orthogonal polarisation states;
polarisation alignment means for aligning the spatially separated orthogonal polarisation states to produce aligned polarisation states:
a first non-reciprocal rotator for rotating said aligned polarisation states in a non-reciprocal manner;
a second polarisation separation means for spatially translating said aligned polarisation states;
focussing means for focussing said polarisation states;
a third polarisation separation means for further spatially translating said aligned polarisation states to produce translated polarisation states;
a second non-reciprocal rotator for rotating said translated polarisation states in a non-reciprocal manner to produce second rotated polarisation states;
a polarisation alignment means for rotating one of said second rotated polarisation state with respect to a second to produce second orthogonal polarisation states; and
a fourth polarisation dependant separation means for further spatially separating said second orthogonal polarisation states to produce separated polarisation output states.

8. A device as claimed in claim 7 further comprising:
a second polarisation alignment means for rotating one of said separated polarisation output states with respect to a second to produce aligned spatially separated polarisation output states.

9. A method of manipulating and transmitting the polarisation states of a first, second and third input optical signal through a series of optical elements, the method comprising the steps of:
(a) projecting said first input optical signal through first predetermined members of a series of polarisation manipulation elements which separate spatially separate and orient orthogonal polarisation states of said input optical signal to produce two spatially separated outputs;
(b) projecting said second and third input optical signal through second predetermined members of said series of polarisation manipulation elements which combine the second and third input optical signal in a substantially orthogonal manner to output a third output.

10. A method as claimed in claim 9 wherein said third output is spatially separated from said first input optical signal.

11. A method as claimed in claim 10 further comprising the step of:
(c) projecting a fourth optical signal from said third output and transmitting said fourth optical signal through said series of polarisation manipulation elements which project said fourth optical signal to a fifth spatial location separated from said two spatially separated outputs.

12. An optical device comprising:
a series of optical manipulation element that spatially separate substantially orthogonal polarisation states of a first input signal input at a first position to produce second and third output signals output at a second and third position respectively, and further spatially combines in a substantially orthogonal manner signals input from said second and third position for output at a fourth position.

13. An optical device comprising:
a polarisation manipulation element that spatially separate substantially orthogonal polarisation states of a first input signal input at a first position to produce second and third output signals output at a second and third position respectively, and further spatially combines in a substantially orthogonal manner signals input from said second and third position for output at a fourth position, and
a second element which includes two input ports located at said second and third position respectively, said second element manipulating each of the second and third output signals in a predetermined manner before returning the signals to said second and third position wherein they are spatially combined by said polarisation manipulation element for output at said fourth position.

14. An optical device as claimed in claim 13 wherein said second element comprises a separate polarisation mode dispersion device for acting on each of said second and third output signals.

15. An optical device as claimed in claim 13 wherein said polarisation mode dispersion device comprises a chirped grating.

16. An optical device as claimed in claim 13 wherein said second element comprises an optical amplifier having an amplifying waveguide interconnecting said second position with said first position.

17. An optical device as claimed in claim 13 wherein said second element comprises a wavelength dependant attenuation filter.

18. An optical device as claimed in claim 13 wherein said second element comprises a wavelength dependant phase filter.
